(19) United States
(12) Patent Application Publication
(10) Pub. No.: US 2021/0133947 A1
(43) Pub. Date: May 6, 2021

(54) DEEP NEURAL NETWORK WITH IMAGE QUALITY AWARENESS FOR AUTONOMOUS DRIVING

(71) Applicants: Dalong Li, Troy, MI (US); Stephen Horton, Rochester, MI (US); Neil R Garbacik, Lake Orion, MI (US)

(72) Inventors: Dalong Li, Troy, MI (US); Stephen Horton, Rochester, MI (US); Neil R Garbacik, Lake Orion, MI (US)

(21) Appl. No.: 16/670,575

(22) Filed: Oct. 31, 2019

(51) Int. Cl. G06T 7/00; G06K 9/00; G05D 1/00; G01S 17/89; G01S 17/87; G01S 17/93; G05D 1/02

(52) U.S. Cl. CPC G06T 7/0002; G06K 9/00791; G05D 1/0088; G01S 17/89; G01S 17/87; G05D 2201/0213; G05D 1/0248; G06T 2207/30168; G06T 2207/30252; G06T 2207/20084; G06T 2207/10028; G01S 17/936

(57) ABSTRACT

An autonomous driving technique comprises determining an image quality metric for each image frame of a series of image frames of a scene outside of a vehicle captured by a camera system and determining an image quality threshold based on the image quality metrics for the series of image frames. The technique then determines whether the image quality metric for a current image frame satisfies the image quality threshold. When the image quality metric for the current image frame satisfies the image quality threshold, object detection is performed by at least utilizing a first deep neural network (DNN) with the current image frame. When the image quality metric for the current image frame fails to satisfy the image quality threshold, object detection is performed by utilizing a second, different DNN with the information captured by another sensor system and without utilizing the first DNN or the current image frame.

### FIELD

The present application generally relates to vehicle autonomous driving systems and, more particularly, to a deep neural network (DNN) with image quality awareness.

### BACKGROUND

Some vehicles are equipped with an autonomous driving system that is configured to perform one or more autonomous driving features (adaptive cruise control, lane centering, collision avoidance, etc.). One important aspect of vehicle autonomous driving systems is object detection. This typically involves using a machine-trained model (e.g., a deep neural network, or DNN) to detect objects in image frames capturing a scene outside of the vehicle (e.g., in front of the vehicle). Conventional autonomous driving systems typically assume all captured image frames to be of acceptable quality for object detection purposes. Some captured image frames, however, could have poor quality and thus could not be suitable for accurate object detection. Potential sources of poor image frame quality include, but are not limited to, motion blur (e.g., a shaking of the camera system) and fog/moisture/dust on the camera system lens. Accordingly, while conventional autonomous driving systems do work well for their intended purpose, there exists an opportunity for improvement in the relevant art.

### SUMMARY

According to one example aspect of the invention, an autonomous driving system for a vehicle is presented. In one exemplary implementation, the autonomous driving system comprises: a camera system configured to capture a series of image frames of a scene outside of the vehicle, the series of image frames comprising a current image frame and at least one previous image frame, a sensor system that is distinct from the camera system and that is configured to capture information indicative of a surrounding of the vehicle, and a controller configured to: determine an image quality metric for each image frame of the series of image frames, the image quality metric being indicative of a non-Gaussianness of a probability distribution of the respective image frame, determine an image quality threshold based on the image quality metrics for the series of image frames, determine whether the image quality metric for the current image frame satisfies the image quality threshold, when the image quality metric for the current image frame satisfies the image quality threshold, perform object detection by at least utilizing a first deep neural network (DNN) with the current image frame, and when the image quality metric for the current image frame fails to satisfy the image quality threshold, perform object detection by utilizing a second, different DNN with the information captured by the sensor system and without utilizing the first DNN or the current image frame.

In some implementations, the image quality metric is a kurtosis value. In some implementations, when the image quality metric for the current image frame satisfies the image quality threshold, the controller is configured to perform object detection by: using the first DNN, identifying one or more object areas in the current image frame, each identified object area being a sub-portion of the image frame, determining a kurtosis value for each identified object area, and utilizing the one or more kurtosis values for the one or more identified object areas as an input for performing object detection using the first DNN to generate a list of any detected objects.

In some implementations, the controller is configured to determine the kurtosis value for a particular image frame as the normalized fourth central moment of a random variable x representative of the particular image frame:

$$k ( x ) = \frac{E ( {( x - μ )}^{4} )}{{σ}^{4}} ,$$

where k(x) represents the kurtosis value, μ represents the mean of x, σ represents its standard deviation, and E(x) represents the expectation of the variable.

In some implementations, the controller is configured to determine the image quality threshold based on a mean and a standard deviation of kurtosis values for the series of image frames. In some implementations, the controller is configured to determine the image quality threshold T as follows:

T=c*m+3*std,

where c is a constant, m is the mean of the kurtosis values for the series of image frames, and std represents the standard deviation of the kurtosis values for the series of image frames.

In some implementations, the sensor system is a light detection and ranging (LIDAR) system. In some implementations, the second DNN is configured to analyze only LIDAR point cloud data generated by the LIDAR system. In some implementations, the first DNN is configured to analyze both the current image frame and LIDAR point cloud data generated by the LIDAR system. In some implementations, the camera system is an exterior, front-facing camera system.

According to another example aspect of the invention, an autonomous driving method for a vehicle is presented. In one exemplary implementation, the autonomous driving method comprises: receiving, by a controller of the vehicle and from a camera system of the vehicle, a series of image frames of a scene outside of the vehicle, the series of image frames comprising a current image frame and at least one previous image frame, receiving, by the controller and from a sensor system of the vehicle that is distinct from the camera system, information indicative of a surrounding of the vehicle, determining, by the controller, an image quality metric for each image frame of the series of image frames, the image quality metric being indicative of a non-Gaussianness of a probability distribution of the respective image frame, determining, by the controller, an image quality threshold based on the image quality metrics for the series of image frames, determining, by the controller, whether the image quality metric for the current image frame satisfies the image quality threshold, when the image quality metric for the current image frame satisfies the image quality threshold, performing, by the controller, object detection by at least utilizing a first DNN with the current image frame, and when the image quality metric for the current image frame fails to satisfy the image quality threshold, performing, by the controller, object detection by utilizing a second, different DNN with the information captured by the sensor system and without utilizing the first DNN or the current image frame.

In some implementations, the image quality metric is a kurtosis value. In some implementations, when the image quality metric for the current image frame satisfies the image quality threshold, the perform object detection comprises: using the first DNN, identifying, by the controller, one or more object areas in the current image frame, each identified object area being a sub-portion of the image frame, determining, by the controller, a kurtosis value for each identified object area, and utilizing, by the controller, the one or more kurtosis values for the one or more identified object areas as an input for performing object detection using the first DNN to generate a list of any detected objects.

In some implementations, the kurtosis value for a particular image frame is determined as the normalized fourth central moment of a random variable x representative of the particular image frame:

$$k ( x ) = \frac{E ( {( x - μ )}^{4} )}{{σ}^{4}} ,$$

where k(x) represents the kurtosis value, μ represents the mean of x, σ represents its standard deviation, and E(x) represents the expectation of the variable.

In some implementations, the image quality threshold is determined based on a mean and a standard deviation of kurtosis values for the series of image frames. In some implementations, the image quality threshold T is determined as follows:

T=c*m+3*std,

where c is a constant, m is the mean of the kurtosis values for the series of image frames, and std represents the standard deviation of the kurtosis values for the series of image frames.

In some implementations, the sensor system of the vehicle is a LIDAR system. In some implementations, the second DNN is configured to analyze only LIDAR point cloud data captured by the LIDAR system. In some implementations, the first DNN is configured to analyze both the current image frame and LIDAR point cloud data generated by the LIDAR system. In some implementations, the camera system is an exterior, front-facing camera system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle having an autonomous driving system according to the principles of the present disclosure;

FIG. 2 is a functional block diagram of an example object detection architecture according to the principles of the present disclosure; and

FIG. 3 is a flow diagram of an example autonomous driving method according to the principles of the present disclosure.

### DESCRIPTION

As discussed above, there exists an opportunity for improvement in the art of autonomous driving systems and, in particular, in the art of object detection. Accordingly, autonomous driving systems and methods having improved object detection capability are presented. It will be appreciated that the term “autonomous” as used encompasses both fully-autonomous and semi-autonomous (e.g., advanced driver assistance, or ADAS) features (adaptive cruise control, lane centering, collision avoidance, etc.). The techniques of the present disclosure determine an image quality metric for each image frame of a captured series of image frames (e.g., a current captured image frame and at least one previously captured image frame. This image quality metric is indicative of a non-Gaussianness of a probability distribution of the particular image frame, with higher quality (e.g., sharper) image frames having higher or maximum non-Gaussian probability distributions. In one exemplary implementation, the image quality metric is a kurtosis value, which is indicative of the normalized fourth-order central or L-moment. Lower kurtosis values are indicative of higher non-Gaussian probability distributions and vice-versa. The techniques then determine an image quality threshold based on the image quality metrics for the series of image frames.

In other words, past image frames are used to continuously determine this adaptive image quality threshold. The current image frame is then determined to be of an acceptable quality when its image quality metric satisfies the adaptive image quality threshold. When the current image frame is of acceptable quality, the current image frame is analyzed using a first machine-trained deep neural network (DNN) for object detection, possible in conjunction or in fusion with another sensor system (e.g., a light detection and ranging, or LIDAR system). In some implementations, object areas (e.g., sub-portions) of the image are analyzed to determine their kurtosis values and this is utilized as an input to the first DNN (e.g., a confidence metric). When the current image frame is of unacceptable quality, however, the current image frame is ignored and another sensor system (e.g., the LIDAR system) is utilized with a second DNN for object detection without using the first DNN or the current image frame.

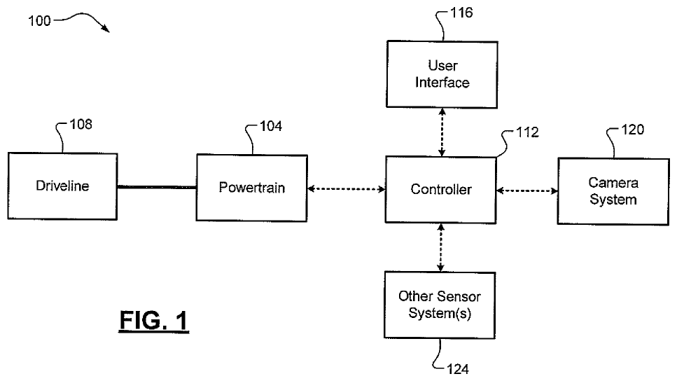

Referring now to FIG. 1, a functional block diagram of an example vehicle 100 having an autonomous driving system according to the principles of the present disclosure. The vehicle 100 comprises a powertrain (an engine, an electric motor, combinations thereof, etc.) that generates drive torque. The drive torque is transferred to a driveline 108 of the vehicle 100 for propulsion of the vehicle 100. A controller 112 controls operation of the powertrain 108 to achieve a desired amount of drive torque, e.g., based a driver torque request provided via a user interface 116 (e.g., an accelerator pedal). The controller 112 also implements autonomous driving features. The autonomous driving system of the present disclosure therefore generally comprises the controller 112, a camera system 120, and one or more other sensor systems 124, but it will be appreciated that the autonomous driving system could include other non-illustrated components (a steering actuator, a brake system, etc.) for implementing specific autonomous driving features (adaptive cruise control, lane centering, collision avoidance, etc.).

The camera system 120 is any suitable camera or system of multiple cameras that is/are configured to capture image frames of a scene outside of the vehicle 100. In one exemplary implementation, the camera system 120 is an external front-facing camera system (e.g., for capturing image frames of a scene in front of and at least partially on the sides of the vehicle 100). When the camera system 120 is an external or exterior camera system, a lens of the camera system 120 is exposed to the environment outside of the vehicle 100. In this regard, the lens of the camera system 120 could be exposed to fog/moisture/dust or other things that could cause it to capture poor quality image frames. As previously discussed, the camera system 120 could also be susceptible to shaking or jarring due to uneven road conditions. In one exemplary implementation, the one or more other sensor systems 124 comprise a LIDAR system that is configured to emit light pulses that are reflected off of objects and recaptured by the LIDAR system to generate LIDAR point cloud data, but it will be appreciated that the one or more other sensor systems 124 could comprise other sensors or sensor systems (e.g., radio detection and ranging, or RADAR) or other object proximity sensing system.

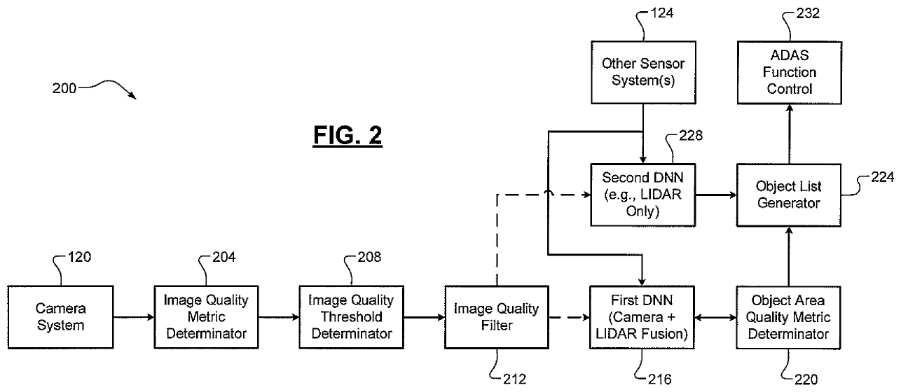

Referring now to FIG. 2, an example object detection architecture 200 is illustrated. It will be appreciated that the object detection architecture could be implemented (e.g., as software) by controller 112 or another suitable device of the autonomous driving system of the vehicle 100. An image quality metric determinator 204 receives a series of image frames (e.g., across a sliding time window) from the camera system 120 and determines an image quality metric for each image frame. The image quality metric is indicative of a non-Gaussianness of a particular image frame's probability distribution. Higher quality (e.g., sharper) images have high or maximum non-Gaussian probability distributions, whereas lower quality (e.g., blurry) images have more Gaussian probability distributions. In one exemplary implementation, the image quality metric is a kurtosis value, which is indicative of the normalized fourth-order central or L-moment of a random variable x.

For image frames, this random variable x represents an array or matrix of pixel color values. In one exemplary implementation, the kurtosis value for a particular image frame x is calculated using the following equation:

$$k ( x ) = \frac{E ( {( x - μ )}^{4} )}{{σ}^{4}} , \qquad ( 1 )$$

where k(x) represents the kurtosis value, μ represents the mean of x, σ represents its standard deviation, and E(x) represents the expectation of the image frame x. An image quality threshold determinator 208 determines an image quality threshold based on the image quality metrics of the series of image frames. The series of image frames could also be referred to as x(t), x(t−1), . . . x(t−n), where t is the current time (and x(t) is the current image frame) and the series of images goes back n seconds or samples. In one exemplary implementation, the image quality threshold determinator 208 determines the image quality threshold based on a mean and a standard deviation of kurtosis values for the series of image frames. In other words, the image quality threshold is adaptive in that it takes into account past image frames and is continuously changing or being updated.

In one exemplary implementation, the image quality threshold determinator 208 determine the image quality threshold (T) using the following equation:

T=c*m+3*std (2),

where c is a calibratable constant, m is the mean of the kurtosis values for the series of image frames, and std represents the standard deviation of the kurtosis values for the series of image frames. It will be appreciated, however, that other suitable equations could be utilized to calculate the image quality threshold. An image quality filter 212 determines whether the image quality metric for the current image frame satisfies the image quality threshold. These image quality metrics and the image quality threshold correspond to the image frames as a whole, as opposed to sub-portions of the image frames as discussed in greater detail below. When the image quality metric for the current image frame satisfies the image quality threshold, the first DNN 216 is utilized for object detection. The first DNN 216 utilizes at least the current image frame and, in some cases, other data, such as LIDAR point cloud data from the other sensor system(s) 124.

When the image quality metric fails to satisfy the image quality threshold, the second DNN 228 is utilized for object detection. The second DNN 220 utilizes only other data, such as LIDAR point cloud data, and not the first DNN or the current image frame. In other words, the current image frame has been determined to be of too low a quality to be reliable for object detection purposes. In some implementations, the object detection using the first DNN 216 further comprises an object area quality metric determinator 220. This involves utilizing the first DNN 216 to identify one or more object areas (e.g., sub-portions) of the current image frame that each has an acceptable likelihood of including an object for detection. For each identified object area, an image quality metric (e.g., a kurtosis value) could then be determined and this additional data could be utilized as another input to the first DNN 216 for object detection or as a confidence metric down the line, such as when generating a list of one or more detected objects at 224. This list of one or more detected objects is then utilized by an ADAS function controller 232 (adaptive cruise control, collision avoidance, etc.).

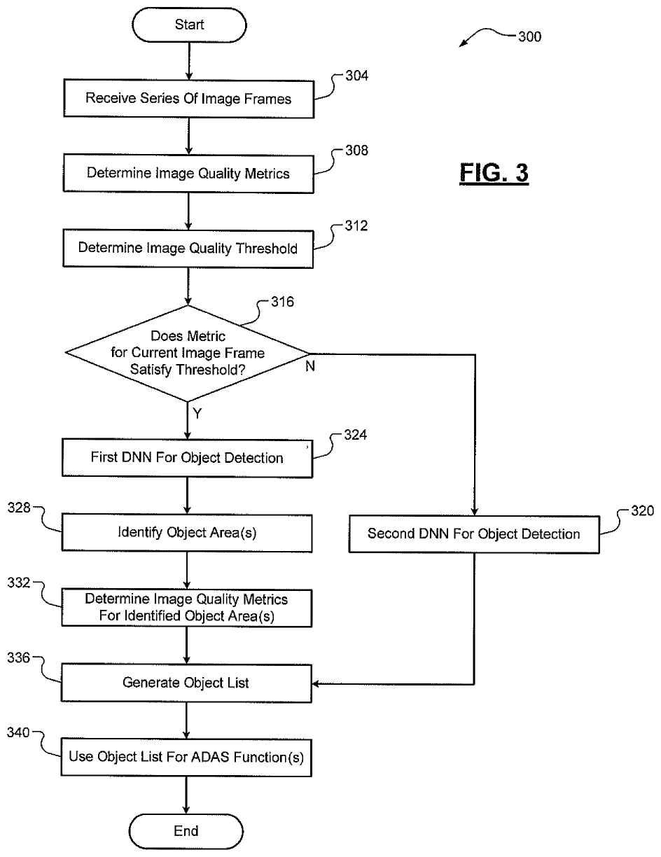

Referring now to FIG. 3, a flow diagram of an example autonomous driving method 300 is illustrated. At 304, the controller 112 receives a series of image frames from the camera system 120 of a scene outside of the vehicle 100. The series of image frames comprises a current image frame and at least one previous image frame. At 308, the controller 112 determines an image quality metric for each image frame of the series of image frames, the image quality metric being indicative of a non-Gaussianness of a probability distribution of the respective image frame. As previously discussed, this image quality metric could be a kurtosis value and, in some implementations, could be calculated using Equation (1) herein. At 312, the controller 112 determines an image quality threshold based on the image quality metrics for the series of image frames. In some implementations, this threshold could be calculated using Equation (2) herein. At 316, the controller 112 determines whether the image quality metric for the current image frame satisfies the image quality threshold. When the image quality metric satisfies the image quality threshold, the method 300 proceeds to 324. Otherwise, the method 300 proceeds to 320.

At 320, the controller 112 utilizes the second DNN and other data (e.g., LIDAR point cloud data) and not the first DNN or the current image frame for object detection. The method 300 then proceeds to 336. At 324, the controller 112 utilizes the first DNN and at least the current image frame (optionally with additional data, such as LIDAR point cloud data) to perform object detection. This could include optional 328 where the controller 112 identifies one or more object areas in the current image frame and optional 332 where the controller 112 determines image quality metrics (e.g., kurtosis values) for each identified object area, which could then be utilized as an input or factor by the first DNN or as a confidence metric later on. The method 300 then proceeds to 336. At 336, the controller 112 generates a list of one or more detected objects in the current image frame using the first DNN or the second DNN, depending on the result of step 316. At 340, the list of one or more detected objects is used as part of an ADAS function of the vehicle 100 (adaptive cruise control, collision avoidance, etc.). The method 300 then ends or returns to 304 for one or more additional cycles to perform further object detection.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture. It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An autonomous driving system for a vehicle, the autonomous driving system comprising:
a camera system configured to capture a series of image frames of a scene outside of the vehicle, the series of image frames comprising a current image frame and at least one previous image frame;
a sensor system that is distinct from the camera system and that is configured to capture information indicative of a surrounding of the vehicle; and
a controller configured to:
determine an image quality metric for each image frame of the series of image frames, the image quality metric being indicative of a non-Gaussianness of a probability distribution of the respective image frame;
determine an image quality threshold based on the image quality metrics for the series of image frames;
determine whether the image quality metric for the current image frame satisfies the image quality threshold;
when the image quality metric for the current image frame satisfies the image quality threshold, perform object detection by at least utilizing a first deep neural network (DNN) with the current image frame; and
when the image quality metric for the current image frame fails to satisfy the image quality threshold, perform object detection by utilizing a second, different DNN with the information captured by the sensor system and without utilizing the first DNN or the current image frame.

2. The autonomous driving system of claim 1, wherein the image quality metric is a kurtosis value.

3. The autonomous driving system of claim 2, wherein when the image quality metric for the current image frame satisfies the image quality threshold, the controller is configured to perform object detection by:
using the first DNN, identifying one or more object areas in the current image frame, each identified object area being a sub-portion of the image frame;
determining a kurtosis value for each identified object area; and
utilizing the one or more kurtosis values for the one or more identified object areas as an input for performing object detection using the first DNN to generate a list of any detected objects.

4. The autonomous driving system of claim 2, wherein the controller is configured to determine the kurtosis value for a particular image frame as the normalized fourth central moment of a random variable x representative of the particular image frame:
$$k ( x ) = \frac{E ( {( x - μ )}^{4} )}{{σ}^{4}} ,$$
where k(x) represents the kurtosis value, μ represents the mean of x, σ represents its standard deviation, and E(x) represents the expectation of the variable.

5. The autonomous driving system of claim 2, wherein the controller is configured to determine the image quality threshold based on a mean and a standard deviation of kurtosis values for the series of image frames.

6. The autonomous driving system of claim 5, wherein the controller is configured to determine the image quality threshold T as follows:
T=c*m+3*std,
where c is a constant, m is the mean of the kurtosis values for the series of image frames, and std represents the standard deviation of the kurtosis values for the series of image frames.

7. The autonomous driving system of claim 1, wherein the sensor system is a light detection and ranging (LIDAR) system.

8. The autonomous driving system of claim 7, wherein the second DNN is configured to analyze only LIDAR point cloud data generated by the LIDAR system.

9. The autonomous driving system of claim 7, wherein the first DNN is configured to analyze both the current image frame and LIDAR point cloud data generated by the LIDAR system.

10. The autonomous driving system of claim 1, wherein the camera system is an exterior, front-facing camera system.

11. An autonomous driving method for a vehicle, the autonomous driving method comprising:
receiving, by a controller of the vehicle and from a camera system of the vehicle, a series of image frames of a scene outside of the vehicle, the series of image frames comprising a current image frame and at least one previous image frame;
receiving, by the controller and from a sensor system of the vehicle that is distinct from the camera system, information indicative of a surrounding of the vehicle;
determining, by the controller, an image quality metric for each image frame of the series of image frames, the image quality metric being indicative of a non-Gaussianness of a probability distribution of the respective image frame;
determining, by the controller, an image quality threshold based on the image quality metrics for the series of image frames;
determining, by the controller, whether the image quality metric for the current image frame satisfies the image quality threshold;
when the image quality metric for the current image frame satisfies the image quality threshold, performing, by the controller, object detection by at least utilizing a first deep neural network (DNN) with the current image frame; and
when the image quality metric for the current image frame fails to satisfy the image quality threshold, performing, by the controller, object detection by utilizing a second, different DNN with the information captured by the sensor system and without utilizing the first DNN or the current image frame.

12. The autonomous driving method of claim 11, wherein the image quality metric is a kurtosis value.

13. The autonomous driving method of claim 12, wherein when the image quality metric for the current image frame satisfies the image quality threshold, the perform object detection comprises:
using the first DNN, identifying, by the controller, one or more object areas in the current image frame, each identified object area being a sub-portion of the image frame;
determining, by the controller, a kurtosis value for each identified object area; and
utilizing, by the controller, the one or more kurtosis values for the one or more identified object areas as an input for performing object detection using the first DNN to generate a list of any detected objects.

14. The autonomous driving method of claim 12, wherein the kurtosis value for a particular image frame is determined as the normalized fourth central moment of a random variable x representative of the particular image frame:
$$k ( x ) = \frac{E ( {( x - μ )}^{4} )}{{σ}^{4}} ,$$
where k(x) represents the kurtosis value, μ represents the mean of x, σ represents its standard deviation, and E(x) represents the expectation of the variable.

15. The autonomous driving method of claim 12, wherein the image quality threshold is determined based on a mean and a standard deviation of kurtosis values for the series of image frames.

16. The autonomous driving method of claim 15, wherein the image quality threshold T is determined as follows:
T=c*m+3*std,
where c is a constant, m is the mean of the kurtosis values for the series of image frames, and std represents the standard deviation of the kurtosis values for the series of image frames.

17. The autonomous driving method of claim 11, wherein the sensor system of the vehicle is a light detection and ranging (LIDAR) system.

18. The autonomous driving method of claim 17, wherein the second DNN is configured to analyze only LIDAR point cloud data captured by the LIDAR system.

19. The autonomous driving method of claim 17, wherein the first DNN is configured to analyze both the current image frame and LIDAR point cloud data generated by the LIDAR system.

20. The autonomous driving method of claim 11, wherein the camera system is an exterior, front-facing camera system.
